(19) United States
(12) Patent Application Publication
(10) Pub. No.: US 2005/0186944 A1
(43) Pub. Date: Aug. 25, 2005

(54) System and method for voicemail retrieval notification

(75) Inventors: Sandra Lynn True, St. Charles, IL (US); Frances Mu-Fen Chin, Naperville, IL (US); Peggy Hasan, Aurora, IL (US)

Correspondence Address: Richard J. Minnich, Esq.;Fay, Sharpe, Fagan, Minnich & McKee, LLP, Seventh Floor, 1100 superior Avenue, Cleveland, OH, 44114-2518, US

(73) Assignee: Lucent Technologies Inc.

(21) Appl. No.: 10/867,082

(22) Filed: Jun. 14, 2004

Related U.S. Application Data
(63) Continuation-in-part of application No. 10/786,730, filed on Feb. 25, 2004.

(51) Int. Cl. H04M 11/00; H04M 1/64

(52) U.S. Cl. 455/413; 455/466; 455/412.1

(57) ABSTRACT

A method of message delivery using a wireless communications network includes sending a voicemail retrieval notification message to a calling party indicating that a called party has retrieved the calling-party-to-called-party voicemail message. A system for wireless communications network message delivery includes means for sending a voicemail retrieval notification message to the calling party indicating that the called party has retrieved the calling-party-to-called-party voicemail message.

### CROSS REFERENCE TO RELATED APPLICATIONS

This application is a continuation-in-part of prior application Ser. No. 10/786,730 filed Feb. 25, 2004.

### BACKGROUND OF THE INVENTION

This invention relates to the art of telecommunications and more particularly to a system and method for notifying a calling party that a called party has retrieved their voicemail message.

Telecommunications networks, including wireless communications networks, provide a voicemail system to enable a calling party to leave a message for a called party when the called party is already on the line or not available to answer the incoming call. The voicemail system sends the voicemail message to the called party whenever the called party indicates to the voicemail system that they want to retrieve the message.

However, after leaving the voicemail message to the called party, the calling party does not know if called party has retrieved the voicemail message and when. Typically, the calling party must wait for the called party to contact them in response to the voicemail message before the calling party knows that the called party has received their voicemail message.

It is desirable to provide notification to the calling party that the called party has retrieved the voicemail message.

### SUMMARY OF THE INVENTION

A system and method of message delivery using a wireless communications network is provided.

In one aspect of the invention, the method includes sending a voicemail retrieval notification message to the calling party indicating that the called party has retrieved the calling-party-to-called-party voicemail message.

In another aspect of the invention, the system includes means for sending a voicemail retrieval notification message to the calling party indicating that the called party has retrieved the calling-party-to-called-party voicemail message.

Further scope of the applicability of the present invention will become apparent from the detailed description provided below. It should be understood, however, that the detailed description and specific examples, while indicating preferred embodiments of the invention, are given by way of illustration only, since various changes and modifications within the spirit and scope of the invention will become apparent to those skilled in the art.

### DESCRIPTION OF THE DRAWINGS

The present invention exists in the construction, arrangement, and combination of the various parts of the device, and steps of the method, whereby the objects contemplated are attained as hereinafter more fully set forth, specifically pointed out in the claims, and illustrated in the accompanying drawings in which:

FIG. 1 is a block diagram illustrating a portion of a wireless communications network in accordance with the invention;

FIG. 2 is a flow chart illustrating the invention;

FIG. 3 is a message flow in accordance with a first embodiment of the invention;

FIG. 4 is a flow chart illustrating the invention;

FIG. 5 is a flow chart illustrating the invention;

FIG. 6 is a flow chart illustrating the invention;

FIG. 7 is a message flow in accordance with a second embodiment of the invention;

FIG. 8 is a message flow in accordance with a third embodiment of the invention; and

FIG. 9 is a message flow in accordance with a fourth embodiment of the invention.

### DETAILED DESCRIPTION OF THE INVENTION

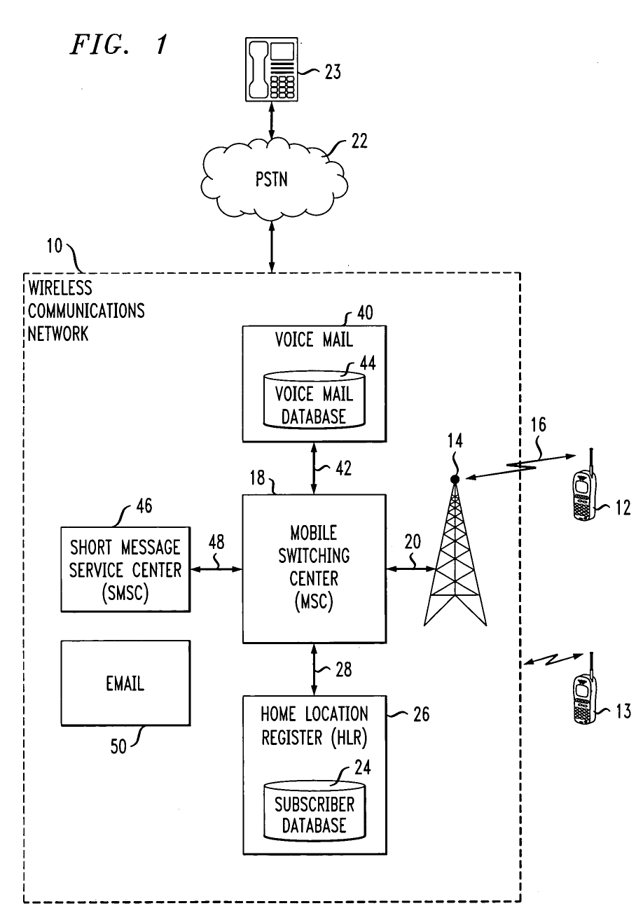

Referring to FIG. 1 a block diagram of a portion of a wireless communications network shown generally at 10. The wireless communications network 10 can be any suitable known wireless communications network including but not limited to CDMA, GSM, etc.

A wireless communications service provider provides the services of the wireless communications network 10 to subscribers. A subscriber can communicate over the wireless communications network 10 using a wireless communications terminal 12. The wireless communications terminal 12, also known as a cellular terminal, can be capable of sending and/or receiving various media such as data, text, special applications, video, etc., as well as voice communications using the wireless communications network 10. Examples of the wireless communications terminal 12 can include, but are not limited to, CDMA, GSM, or any other wireless devices capable of using the wireless communications network 10. For the purposes of example as shall be described in further detail below, the wireless communications terminal 12 is referred to herein as the calling party terminal.

The wireless communications network 10 includes a base station 14 communicating with the calling party terminal 12 over an air interface 16. The wireless communications network 10 also includes a Mobile Switching Center (MSC) 18 communicating with the base station 14 using any suitable known connection 20. The MSC 18 handles the communications of the calling party terminal 12 with the communications network 10 including call set-ups, registration and routing calls to the calling party terminal. In the preferred embodiment, the MSC 18 is a processor-based apparatus with data link interfaces for coupling together other portions of the wireless communications network 10 which are not shown. The MSC 18 can be the calling party terminal's home MSC, or it can be a different MSC in the wireless communications network 10, often referred to as the serving MSC, if the calling party terminal 12 is roaming.

The wireless communications network 10 provides communications between wireless terminals, such as the wireless terminal 12 and another wireless terminal 13. The network 10 can include other MSCs (not shown) for providing communications between wireless terminals, such as wireless terminal 13, and the wireless network 10. Other terminals, such as landline terminal 23, or wireless terminals (not shown) using other wireless communications networks (not shown) can communicate with terminals over the wireless network 10 via the PSTN 22.

The wireless communications network 10 also includes a subscriber database 24 also known as the subscriber profile. The subscriber database 24 includes stored subscriber profile information, which includes identification of the services the network subscribers subscribe to, such as call waiting as well as the services provided by the invention as described below. The subscriber database 24 can be stored on any suitable node in the wireless communications network 10. By way of example, which should not be considered limiting, the subscriber database 24 can be stored on the Home Location Register (HLR) 26. The HLR 26 is connected to the MSC 18 in a known manner at 28. The HLR 26 can also store information such as user identification, user security information, including network access control information for authentication and authorization, user location information for user registration, etc.

The wireless communications network 10 also includes a voicemail system 40 connected to the MSC 18 in a known manner at 42. The voicemail system 40 stores voicemail messages made by the calling party which are destined for the called party, referred to herein as calling-party-to-called-party voicemail messages, on a voice mailbox database 44. The called party can access the voicemail system 40 and retrieve voicemail messages left for them on the voice mailbox database 44 via the wireless network 10.

The wireless communications network 10 can also include a Short Message Service Center (SMSC) element 46 connected to the MSC 18 at 48 for delivering SMS messages to wireless terminals 12, 13 or to the calling party via any other known device. The SMSC 46 provides a mechanism for transmitting SMS messages to and from devices via the home/serving MSC 18. The SMSC 46 acts as a store-and-forward system for SMS messages, providing the mechanisms required to find the subscriber terminal MSC 18 for transport of SMS messages therebetween.

SMS makes use of the Mobile Application Part (MAP), which defines the methods and mechanisms of communication in wireless networks and employs the services of the SS7 Transactional Capabilities Application Part (TCAP). The capabilities of the wireless terminal 12 can vary depending on the wireless technology supported by the terminal. The MAP layer defines the operations necessary to support SMS. Both American and International standards bodies have defined a MAP layer using the services of the SS7 TCAP. The American standard is published by Telecommunication Industry Association and is referred to as IS-41. The International standard is defined by the European Telecommunications Standards Institute (ETSI) and is referred to as GSM MAP.

The wireless communications network 10 also includes an email interface 50 for sending an email message to the calling party as described in further detail below. The calling party can receive the email message on any suitable known device.

In accordance with the invention, a calling party calls a called party. The calling party leaves a calling-party-to-called-party voicemail message on the voicemail system 40. For the purposes of simplicity and example, which should not be limiting, the calling party is using the wireless terminal 12, although the calling party terminal can be a wireline terminal 23 or another wireless terminal (not shown) connected to the wireless network 10 via the PSTN 22. Also, for the purposes of simplicity and example, which should not be limiting, the called party is using the wireless terminal 13, although the called party terminal can be the wireline terminal 23 or another wireless terminal (not shown) connected to the wireless network 10 via the PSTN 22. Further, for the purposes of simplification in the examples and description provided herein and unless stated otherwise, delivering information and/or a message to the calling party also refers to delivering the information and/or message to the calling party terminal 12 and delivering information and/or a message to the called party also refers to delivering the information and/or message to the called party terminal 13.

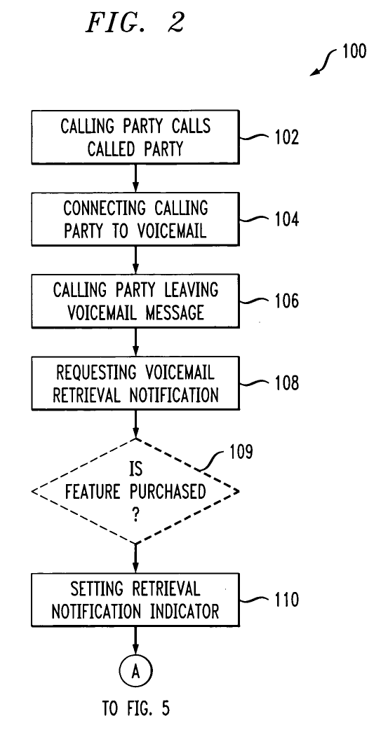

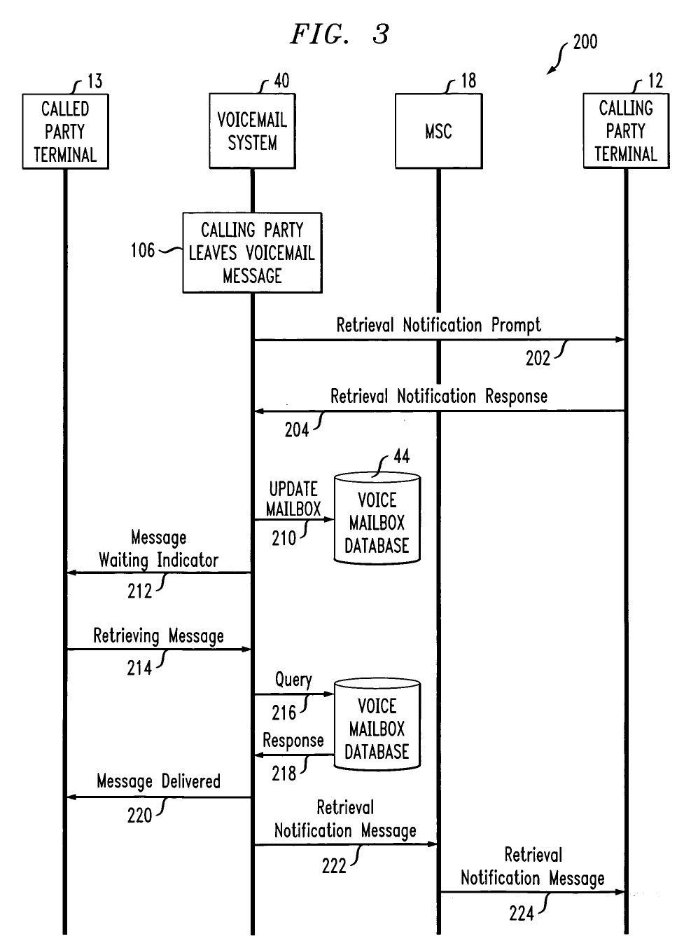

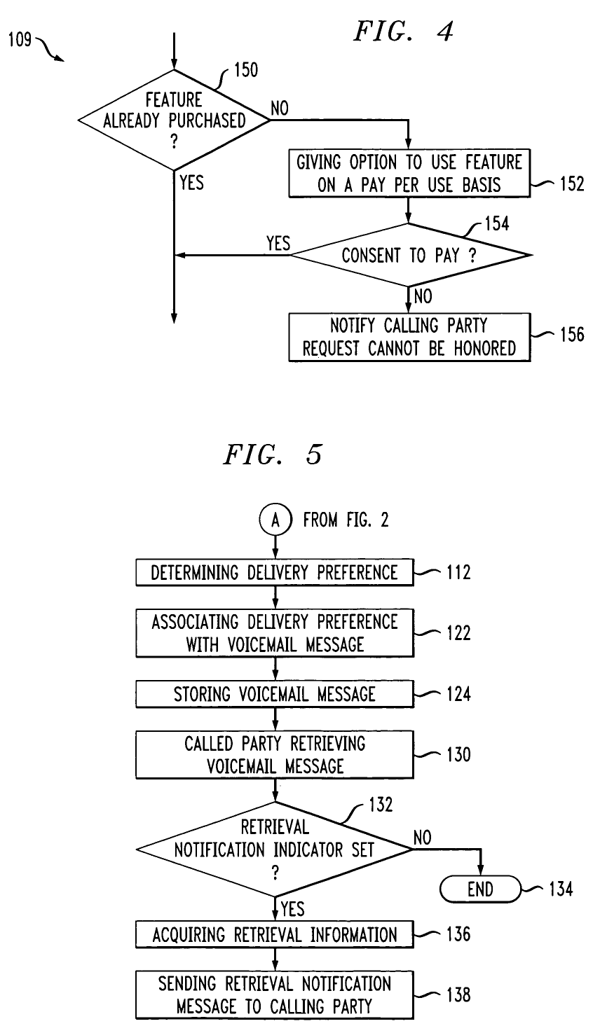

Referring now to FIG. 2, a method of message delivery using a wireless communications network is shown generally at 100. The method 100 includes the calling party calling the called party at 102 using the calling party terminal 12. The method 100 also includes connecting the calling party terminal 12 to the voicemail system 40 at 104 thereby connecting the calling party with the called party's voicemail. The calling party may reach the voicemail system 40 for a variety of reasons including, but not limited to, the called party being unavailable to answer the called party terminal 13, the called party already using the line, the called party terminal 13 being turned off, etc.

The method 100 also includes the calling party leaving a calling-party-to-called-party voicemail message on the voicemail system 40 as shown at 106. The calling party can leave the voicemail message by recording a voice message on the voicemail system 40 using the calling party terminal 12.

The method 100 also includes the calling party requesting voicemail retrieval notification at 108. The network 10, such as the voicemail system 40 or another suitable network node including but not limited to the MSC 18, can send a Retrieval Notification Prompt message to the calling party terminal 12 providing the calling party with the option of being notified when the called party retrieves the calling-party-to-called-party voicemail message. The calling party can be notified via a voicemail retrieval notification message as described in further detail below. The voicemail retrieval notification message can be delivered to the calling party in a variety of ways in accordance with a delivery preference as shall be described in further detail below.

A message flow diagram is shown generally at 200 in FIG. 3 for an example in which the delivery preference is for delivering the voicemail retrieval notification message to the calling party terminal 12. The message flow 200 includes the voicemail system 40 sending the Retrieval Notification Prompt message to the calling party terminal 12 at 202, although any other suitable network node, including but not limited to the MSC 18 can do so. The Retrieval Notification Prompt message 202 can include verbal prompt asking the calling party if they would like to request Voicemail Retrieval Notification. The calling party can request Voicemail Retrieval Notification in any suitable manner, such as for example pressing a key on the calling party terminal 12. The calling party requests Voicemail Retrieval Notification, sending a Retrieval Notification Response back to the voicemail system 40 at 204.

Referring now to FIGS. 2 and 4, the method 100 can optionally determine if the voicemail retrieval notification feature has been purchased at 109. FIG. 4 illustrates an example of how the optional feature 109 can be implemented, though it should be appreciated that this feature can be implemented in other ways. At 150, it can be determined whether the subscriber has already purchased the feature, such as for example by subscribing to this feature. The subscriber database 24 can be queried to determine this subscription information as described above or it can be determined in any other suitable manner. If it is found that the calling party has not already purchased this feature at 150, the calling party can be given the option to use the feature on a pay per use basis at 152. If the calling party does not consent to pay for the feature at 154, the calling party can be notified that the request for voicemail retrieval notification cannot be honored using any suitable message at 156.

If the calling party consents to pay for the feature at 154, or the optional step 109 is not included, the method 100 also includes setting a Retrieval Notification Indicator at 110 indicating that the Voicemail Retrieval Notification feature has been activated for the calling-party-to-called-party voicemail message the calling party is leaving on the voicemail system 40 at 106. The Retrieval Notification Indicator can be a tag included with the calling-party-to-called-party voicemail message, such as for example setting a flag, or it can be associated with the calling-party-to-called-party voicemail message in any other suitable manner.

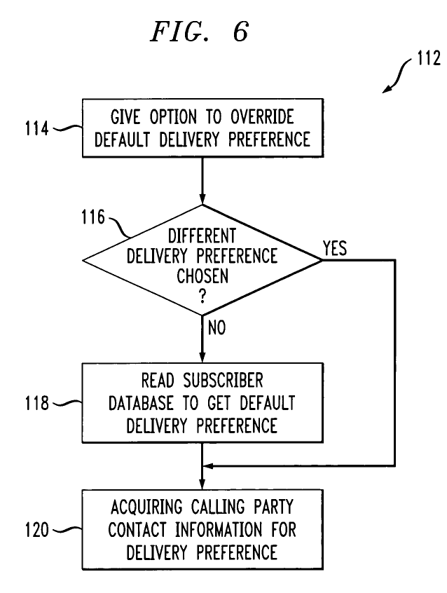

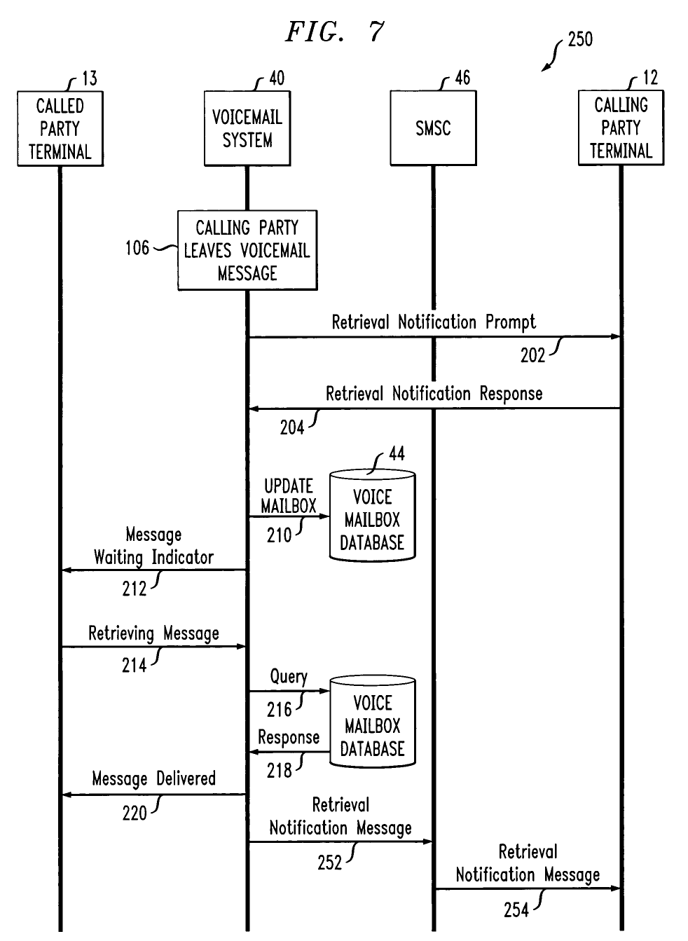

The method 100 also includes determining the calling party's delivery preference for receiving the voicemail retrieval notification message at 112. Referring to FIG. 6, the step of determining the delivery preference 112 can include providing the calling party the option to override the default delivery preference at 114. The default delivery preference can be provided by the calling party in any suitable manner and can be stored on the network 10. Examples of the default delivery preference can include, but are not limited to, an audio/voice message delivered to the calling party terminal, an SMS message delivered to the calling party via any suitable known device, an email message delivered to the calling party via any suitable known device, or a voicemail message delivered to the calling party's voicemail. In an example which should not be limiting, the default delivery preference can be provided by the calling party and stored in the subscriber database 24 when the calling party subscribes to this feature. The calling party can be provided with the option of choosing a different delivery preference at 116. If a new delivery preference is not chosen at 116, the subscriber database 24 can be read to get the default delivery preference at 118.

The method 100 also includes acquiring calling party terminal contact information at 120 for the delivery preference determined at 112. The contact information can include a calling party terminal 12 identifier, such as for example the phone number, an email address, or any other suitable identifier used for delivering the voicemail retrieval message to the calling party via the device defined in the delivery preference determined at 112. The contact information can be stored with the delivery preference.

The delivery preference determined at 112 is associated with the calling-party-to-called-party voicemail message at 122 in any suitable manner. The method 100 also includes storing the calling-party-to-called-party voicemail message in the voicemail system 40 at 124.

Referring again to FIG. 3, the delivery preference which can include the calling party contact information can be stored in the voice mailbox database 44 via an update at 210. The date and time the calling party left the calling-party-called-party voicemail message in the voicemail system 40 at 106 can be also be stored in the voice mailbox database 44. The called party is notified that they have a voicemail message waiting at 212.

Referring now to FIGS. 3 and 5, the method of message delivery 100 also includes the called party retrieving the calling-party-to-called-party voicemail message at 130. The called party sends a message to the voicemail system 40 at 214 indicating that they want to retrieve their voicemail messages. This can be done in any suitable known manner, such as for example by using the called party terminal 13 to call the voicemail system 40 and entering any codes that may be necessary for retrieving their voicemail messages at 214.

The voicemail system 40 queries the voice mailbox database 44 at 216 sending any necessary identification information identifying the called party. The voice mailbox responds at 218 providing the voicemail system 40 with the voicemail messages left for the called party, including the calling-party-to-called-party voicemail message. The voicemail system 40 delivers the called party's voicemail messages, including the calling-party-to-called-party voicemail message, to the called party. For example, the voicemail system 40 can play back the messages recorded and saved on the voice mailbox database 44 to the called party terminal 13 over the network 10.

The voicemail system 40 can determine at 132 whether the retrieval notification indicator has been set at 110 above. If the retrieval notification indicator is set, the method 100 can also include acquiring retrieval information at 136 after the called party retrieves the calling-party-to-called-party voicemail message at 130. The voicemail system 40 acquires retrieval information which can be sent to the calling party in the voicemail retrieval notification message. The retrieval information can include the phone number of the called party terminal 13 used to retrieve the voicemail message. The retrieval information can also include the date and time that the called party retrieved the message, also referred to as the retrieval date and time. The voicemail system 40 can obtain the date and time information from when the voicemail system delivered the calling-party-to-called-party voicemail message to the called party.

The method also includes sending a voicemail retrieval notification message, also referred to as a voicemail retrieval notification acknowledgement message, to the calling party indicating that the called party has retrieved the calling-party-to-called-party voicemail message at 138. In the example provided in FIG. 3 in which the delivery preference is for delivering the voicemail retrieval notification message to the calling party terminal 12, the voicemail system 40 sends the voicemail retrieval notification message to the serving/home MSC 18 of the calling party at 222. The MSC 18 sends the voicemail retrieval notification message to the calling party terminal 12 at 224. The calling party terminal 12 can be a different terminal than the terminal from which the calling party left the calling-party-to-called-party voicemail message at 106. The voicemail retrieval notification message can be private message to the calling party, whereby the called party is not notified that the calling party is receiving the voicemail retrieval notification message. Alternatively, the called party can be notified that the calling party will be receiving the voicemail retrieval notification message when the called party retrieves the calling-party-to-called-party voicemail message at 130.

Referring to FIG. 7, the voicemail retrieval notification message can be sent to the calling party terminal 12 via an SMS message as shown in the message flow diagram indicated generally at 250. Messages similar to the messages described in FIG. 3 above are indicated with similar reference numbers. For this example, the delivery preference is determined to be an SMS message at 112 above. The calling party contact information acquired at 120 includes routing information for sending the SMS message to the calling party terminal. The voicemail system 40 sends a message to the SMS Center 46 at 252 indicating that an SMS voicemail retrieval notification message should be sent to the calling party terminal 12. The message at 252 can include the calling party contact information needed to route the voicemail retrieval notification SMS message to the calling party terminal 12 acquired at 120. The SMS Center 46 sends the voicemail retrieval notification SMS message to the calling party terminal at 254.

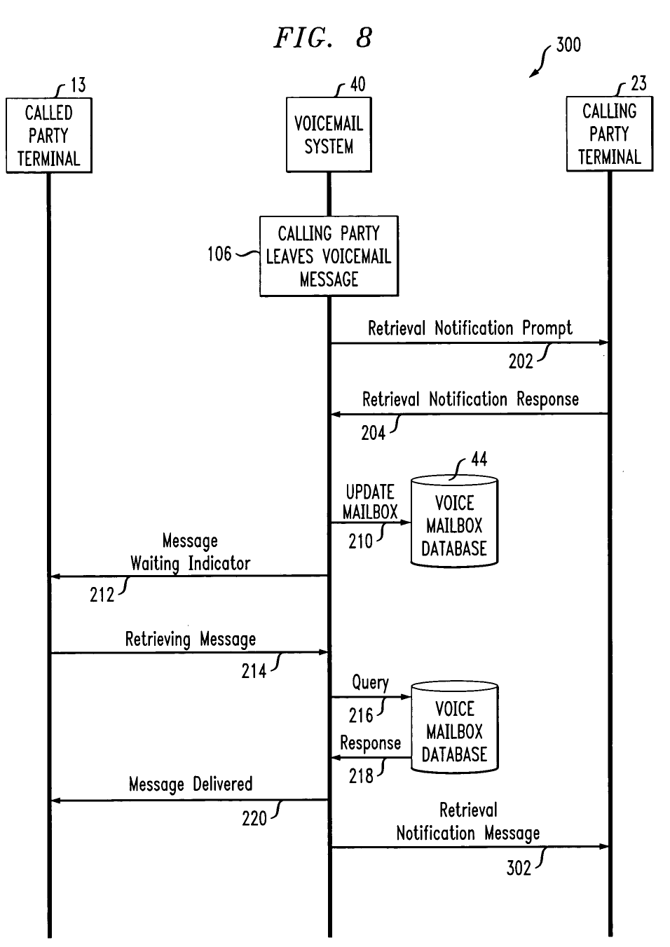

Referring to FIG. 8, the message flow shown generally at 300 illustrates how the voicemail retrieval notification message can be sent to the calling party as a voicemail message as indicated by the delivery preference determined in 112. Messages similar to the messages described in FIG. 3 above are indicated with similar reference numbers. The voicemail retrieval notification message can be saved as a voicemail message for the calling party on the voicemail system 40 and delivered to the calling party terminal at 302 when the calling party retrieves their voicemail messages. The voicemail message can be sent to the calling party on a wireless calling party terminal 12 via the network 10, or to a wireline calling party terminal 23 or a wireless calling party terminal (not shown) in another wireless network via the PSTN 22.

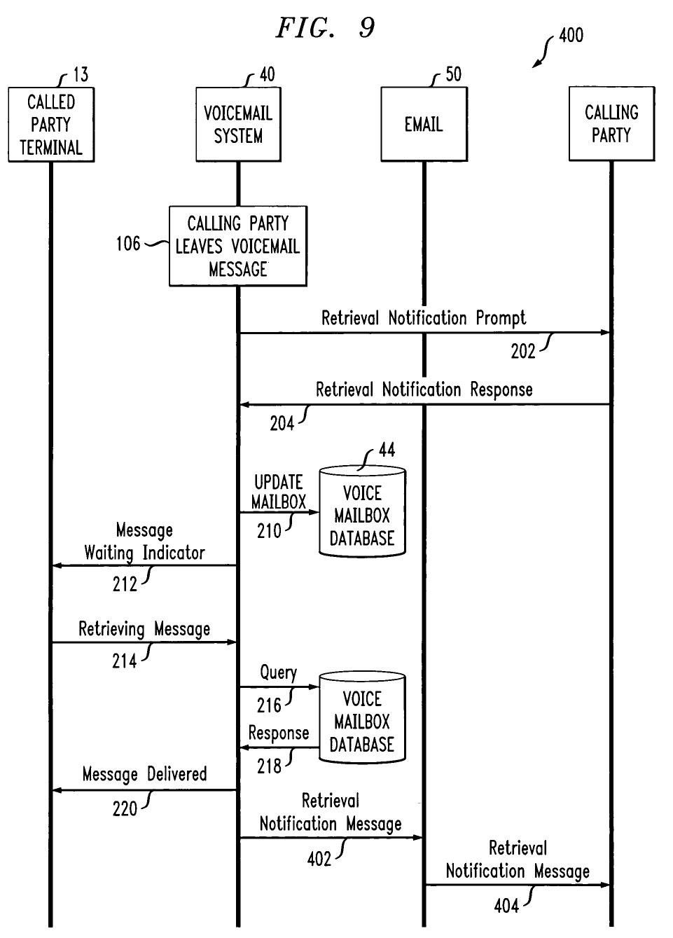

Referring to FIG. 9, the message flow shown generally at 400 illustrates how the voicemail retrieval notification message can be sent to the calling party as an email message as indicated by the delivery preference determined in 112. Messages similar to the messages described in FIG. 3 above are indicated with similar reference numbers. The voicemail retrieval notification message can be generated by the network 10, such as by the voicemail system 40 and sent to the email interface 50 which can send the email message to the calling party via any suitable known device capable of receiving email messages at 404 using the calling party email address acquired at 120 above. Alternatively, the voicemail system 40 can send a message to the email system at 402 indicating that the voicemail retrieval notification message should be sent to the calling party as an email message. The email interface 50 can then generate the voicemail retrieval notification email message and send it to the calling party at 404.

The invention provides notification to the calling party by sending a voicemail retrieval notification message to the calling party indicating that the called party has retrieved the calling-party-to-called-party voicemail message. The voicemail retrieval notification message can include retrieval information, such as for example, the date and time the called party retrieves the voicemail message or the phone number of the called party terminal 13 used to retrieve the voicemail message which can be stored when the voicemail message is retrieved by the called party.

It is also to be appreciated that particular elements or components described herein may have their functionality suitably implemented via hardware, software, firmware or a combination thereof. Additionally, it is to be appreciated that certain elements described herein as incorporated together may under suitable circumstances be stand alone elements or otherwise divided. Similarly, a plurality of particular functions described as being carried out by one particular element may be carried out by a plurality of distinct elements acting independently to carry out individual functions, or certain individual functions may be split-up and carried out by a plurality of distinct elements acting in concert. Alternately, some elements or components otherwise described and/or shown herein as distinct from one another may be physically or functionally combined where appropriate.

The above description merely provides a disclosure of particular embodiments of the invention and is not intended for the purposes of limiting the same thereto. As such, the invention is not limited to only the above-described embodiments. Rather, it is recognized that one skilled in the art could conceive alternative embodiments that fall within the scope of the invention.

1. A method of delivering a message using a wireless communications network comprising:
sending a voicemail retrieval notification message to a calling party indicating that a called party has retrieved a calling-party-to-called-party voicemail message.

2. The method defined in claim 1 further comprising
leaving a calling-party-to-called-party voicemail message on the wireless communications network voicemail system; and
the called party retrieving the voicemail message.

3. The method defined in claim 1, wherein the voicemail retrieval notification message is a Short Message Service (SMS) message and the sending step further comprises sending the SMS message to the calling party terminal.

4. The method defined in claim 1, wherein the voicemail retrieval notification message is a voice message and the sending step further comprises sending the voice message to the calling party.

5. The method defined in claim 1, wherein the voicemail retrieval notification message is a voicemail message and the sending step further comprises sending the voicemail message to the calling party's voicemail.

6. The method defined in claim 1, wherein the voicemail retrieval notification message is an email message and the sending step further comprises sending the email message to the calling party.

7. The method defined in claim 1 further comprising the calling party requesting voicemail retrieval notification.

8. The method defined in claim 7 wherein the requesting step further comprises:
sending a retrieval notification prompt to the calling party; and
receiving a retrieval notification response from the calling party indicating that the calling party is requesting voicemail retrieval notification.

9. The method defined in claim 1 further comprising:
determining if the calling party has purchased the voicemail retrieval notification message feature.

10. The method defined in claim 1 further comprising:
providing the calling party with the option of receiving the voicemail retrieval notification message on a pay per use basis.

11. The method defined in claim 2 further comprising:
setting a retrieval notification indicator indicating that a voicemail retrieval notification message is to be sent to the calling party after the retrieving step.

12. The method defined in claim 1 further comprising:
determining a delivery preference indicating a preferred manner of delivering the voicemail retrieval notification message to the calling party.

13. The method defined in claim 12 wherein the step of determining the delivery preference further comprises:
giving the calling party the option of overriding a default delivery preference thereby choosing a different delivery preference.

14. The method defined in claim 1 wherein the voicemail retrieval notification message includes the retrieval date and time when the called party retrieved the calling-party-to-called-party voicemail message.

15. The method defined in claim 1 wherein the voicemail retrieval notification message is private to the calling party such that the called party is not notified that the calling party is receiving the voicemail retrieval notification message.

16. A method of delivering a message using a wireless communications network comprising:
sending a private voicemail retrieval notification message to a calling party indicating that a called party has retrieved a calling-party-to-called-party voicemail message, wherein the called party is not notified that the calling party is receiving the private voicemail retrieval notification message.

17. A system for voicemail retrieval notification comprising:
means for sending a voicemail retrieval notification message to the calling party indicating that the called party has retrieved a calling-party-to-called-party voicemail message.

18. The system defined in claim 17 further comprising:
means for leaving a calling-party-to-called-party voicemail message on the wireless communications network voicemail system; and
means for the called party receiving the calling-party-to-called-party voicemail message.

19. The system defined in claim 17 further comprising:
means for sending a voicemail retrieval notification message to the calling party indicating the time and date when the called party retrieved the calling-party-to-called-party voicemail message.

20. The system defined in claim 17 further comprising:
means for sending the voicemail retrieval notification message as an SMS message to the calling party.

21. The system defined in claim 17 further comprising:
means for sending the voicemail retrieval notification message as a voicemail message to the calling party.

22. The system defined in claim 17 further comprising:
means for sending the voicemail retrieval notification message as a voice message to the calling party terminal.

23. The system defined in claim 17 further comprising:
means for sending the voicemail retrieval notification message as an email message to the calling party.

24. The system defined in claim 17 further comprising:
means for sending a retrieval notification prompt to the calling party; and
means for receiving a retrieval notification response from the calling party indicating that the calling party is requesting voicemail retrieval notification.

25. The system defined in claim 17 further comprising:
determining if the calling party has purchased the voicemail retrieval notification message feature.

26. The system defined in claim 17 further comprising:
means for providing the calling party with the option of receiving the voicemail retrieval notification message on a pay per use basis.

27. The system defined in claim 17 further comprising:
means for determining a delivery preference indicating a preferred manner of delivering the voicemail retrieval notification message to the calling party.

28. The system defined in claim 17 further comprising
means for giving the calling party the option of overriding a default delivery preference thereby choosing a different delivery preference.

29. The system defined in claim 17 further comprising:
means for including the retrieval date and time when the called party retrieved the calling-party-to-called-party voicemail message in the voicemail retrieval notification message.

30. The system defined in claim 17 wherein the voicemail retrieval notification message is private to the calling party such that the called party is not notified that the calling party is receiving the voicemail retrieval notification message.
